(19) United States
(12) Patent Application Publication
(10) Pub. No.: US 2025/0189395 A1
(43) Pub. Date: Jun. 12, 2025

(54) Pressure Measuring Cell

(71) Applicant: Huba Control AG, Würenlos (CH)

(72) Inventor: Mathias Steglich, Zürich (CH)

(21) Appl. No.: 18/845,055

(22) PCT Filed: Mar. 9, 2023
(86) PCT No.: PCT/EP2023/056023

§ 371 Date: Sep. 9, 2024

(30) Foreign Application Priority Data
Mar. 10, 2022 (CH) CH000253/2022

(51) Int. Cl. G01L 9/04; G01L 9/00

(52) U.S. Cl. CPC G01L 9/04; G01L 9/0051; G01L 2009/0069

(57) ABSTRACT

A pressure measuring cell is described, including a support body and a circular-shaped membrane including a first surface and a second surface, the support body supporting the circular-shaped membrane, wherein the pressure measuring cell further includes a plurality of strain sensitive resistors arranged on the second surface of the circular-shaped membrane and connected in a Wheatstone bridge circuit, wherein at least one strain sensitive resistor is an arc-shaped resistor including an arc-shaped surface area that is radially delimited by an inner circular arc and an outer circular arc.

### CROSS-REFERENCE TO RELATED APPLICATION

This application is the United States national phase of International Patent Application No. PCT/EP2023/056023 filed Mar. 9, 2023, and claims priority to Swiss Patent Application No. CH000253/2022 filed Mar. 10, 2022, the disclosures of each of which are hereby incorporated by reference in their entireties.

### BACKGROUND OF THE INVENTION

### Field of the Invention

The present invention relates to a pressure measuring cell for measuring pressure using a Wheatstone bridge circuit.

### BACKGROUND OF RELATED ART

The pressure of a measurement medium such as a gas or a liquid can be measured using strain sensitive resistors arranged on a deflectable membrane, where a surface of the membrane is facing the measurement medium. The strain sensitive resistors are commonly arranged in a Wheatstone bridge circuit providing a simple and sensitive configuration for pressure sensing.

A piezoresistive pressure sensor using strain sensitive resistors arranged on a membrane in a Wheatstone bridge circuit is for example described in EP 3 279 631 A1. The piezoresistive pressure sensor according to EP 3 279 631 A1 comprises a rigid flat support, a flat flexible membrane having a flat external face exposed to a pressure of a fluid and a flat internal face delimiting in cooperation with a flat internal face of the support a chamber accommodating the deformation of the membrane, an electrical measuring circuit comprising a resistive Wheatstone bridge applied on the flat internal face of the membrane for detecting the deformation of the membrane, and at least an electrical resistor for calibrating the value of the output signal when the fluid is at a reference pressure, the calibration resistor being applied on the flat internal face of the membrane.

### SUMMARY OF THE INVENTION

For sensing the pressure of a measurement medium using a strain sensitive circuit, it is desired to maximize the electrical output signal while keeping the noise low, in order to improve the sensitivity.

It is therefore an object of the invention to provide a pressure measuring cell which at least partially improves the prior art and avoids at least part of the disadvantages of the prior art.

According to the present invention, this object is achieved by the features and advantageous embodiments disclosed herein.

According to an aspect of the invention, this object is particularly achieved by a pressure measuring cell comprising a support body and a circular-shaped membrane with a first surface and a second surface, the support body supporting the membrane, wherein the pressure measuring cell further comprises a plurality of strain sensitive resistors arranged on the second surface of the membrane and connected in a Wheatstone bridge circuit, wherein at least one strain sensitive resistor is an arc-shaped resistor comprising an arc-shaped surface area that is radially delimited by an inner circular arc and an outer circular arc.

By providing at least one strain sensitive resistor as an arc-shaped resistor, the at least one strain sensitive resistor can better be conformed to the symmetry of the circular-shaped membrane. Due to the rotational symmetry of the membrane, the distribution of strain and/or stress of the membrane due to pressure variations in the measurement medium tend to exhibit an at least partially corresponding symmetry.

For a strain sensitive resistor with a geometry deviating from the symmetry of the membrane, for example a rectangular strain sensitive resistor, the probability of parts of the strain sensitive resistor being arranged on non-optimal positions of the membrane is increased. For example, one part of the strain sensitive resistor may be arranged at a position of the membrane with small strain, whereas another part of the same strain sensitive sensor may be arranged at a position of the membrane with large strain. In order to reduce such detrimental effects due to the mismatch in symmetry, it is typically desired to keep the area of an e.g. rectangular strain sensitive resistor small with respect to the size of the membrane.

Providing an arc-shaped strain sensitive resistor where the symmetry corresponds to the symmetry of the membrane, allows to address the challenges of symmetry mismatch between strain sensitive resistor and membrane, as the arc-shaped strain sensitive resistor is more likely to sense a homogeneous and sufficiently large strain across the surface area of the arc-shaped strain sensitive resistor, yielding a more accurate output signal of the pressure variations to be sensed. Further, the size of the arc-shaped strain sensitive resistor can be increased with respect to the membrane area compared to e.g. rectangular strain sensitive resistors, which improves the signal-to-noise ratio. As the area of the arc-shaped strain sensitive resistor does not have to be limited with respect to the membrane, miniaturization of the membrane and therefore the pressure measuring cell can be facilitated.

Providing the at least one strain sensitive resistor with an arc-shaped surface area therefore allows to improve accuracy and sensitivity of pressure sensing by the pressure measuring cell.

Typically, the first surface of the membrane is facing the measurement medium of which the pressure variations are to be sensed by the pressure measuring cell. The support body may comprise a shape of a cylinder with a cavity which is axially delimited at a first side by the first surface of the membrane and open at a second side. The measurement medium may be accommodated the cavity of the support body. In some embodiments, the support body supports the membrane at the first surface and/or at its edge. In some embodiments, the support body may comprise a disc or a torus encircling the membrane at its first surface and/or at its edge. The torus may be formed by a sealing ring.

Preferably, the at least one arc-shaped resistor is arranged on the circular-shaped membrane such that the inner circular arc and the outer circular arc are parallel to a circular edge of the circular-shaped membrane.

By arranging the at least one arc-shaped resistor such that its circular arcs or edges, respectively, are parallel to the circular edge of the membrane, conformity with the symmetry of the membrane can be optimized.

Further, two or more arc-shaped resistors may be arranged on a circle parallel to the circular edge of the membrane.

In some embodiments, the at least one arc-shaped resistor comprises a first electrical contact which is arranged at the inner circular arc and a second electrical contact which is arranged at the outer circular arc.

Arranging the first electrical contact at the inner circular arc and the second electrical contact at the outer circular arc provides the advantage that a predominantly radial current flow can be achieved. Compared to an azimuthal current flow, where the current density is strongly enhanced in radially inner sections of an arc-shaped resistor, a more homogeneous and sufficiently low current density can be maintained.

In some embodiments, the first electrical contact extends along the inner circular arc and/or the second electrical contact extends along the outer circular arc.

In particular, the first electrical contact may extend along the entire inner circular arc and/or the second electrical contact may extend along the entire outer circular arc of the arc-shaped resistor.

In some embodiments, the at least one arc-shaped resistor is delimited in azimuthal direction by line segments which coincide with radial lines extending from the center of the circular-shaped membrane.

In some embodiments, the at least one arc-shaped resistor is a sheet resistor with a filled surface area.

Providing the arc-shaped resistor as a sheet resistor with a filled surface area has the advantage that a homogeneous and sufficiently low current density can be maintained across the area of the arc-shaped resistor.

In some embodiments, the plurality of strain sensitive resistors comprises two, three, four, five, six, seven or eight arc-shaped resistors.

Increasing the number of arc-shaped strain sensitive resistors provides the advantage that the symmetry of the Wheatstone bridge circuit can increasingly be adapted to the symmetry of the membrane.

In some embodiments, two first arc-shaped resistors are arranged on a first circle parallel to a circular edge of the circular-shaped membrane.

Depending on the requirements of optimizing the output signal of the Wheatstone bridge circuit, the first circle may be a circle along which the strain and/or stress of the membrane due to pressure variations in the measurement medium may be positive or negative.

Further, two second arc-shaped resistors may be arranged on a second circle parallel to the first circle, wherein the radius of the second circle is larger than the radius of the first circle.

In particular, the first circle may be a circle along which the strain and/or stress of the membrane due to pressure variations in the measurement medium is positive. The first circle may therefore be arranged in an inner region of the membrane. The second circle may be a circle along which the strain and/or stress of the membrane due to pressure variations in the measurement medium is negative. The second circle may therefore be arranged in an outer region of the membrane. By arranging four arc-shaped resistors of the Wheatstone bridge circuit pairwise on the two different circles with positive and negative strain and/or stress, the output signal of the Wheatstone bridge circuit can be increased.

In some embodiments, four arc-shaped resistors are arranged on a circle parallel to a circular edge of the circular-shaped membrane.

In some embodiments, the at least one arc-shaped resistor covers a circular arc with an angle between 10° and 180°, preferably between 20° and 80°.

As already mentioned, it is possible to provide the arc-shaped resistor with a large surface area compared to e.g. rectangular strain sensitive resistors while ensuring high sensitivity and accuracy of pressure sensing. The surface area of the arc-shaped resistor can be adjusted by choosing a suitable angle of the circular arc.

In some embodiments, the at least one arc-shaped resistor is a thick film resistor.

In some embodiments, the at least one arc-shaped resistor is a thin film resistor.

For embodiments, where the pressure measuring cell comprises also rectangular strain sensitive resistors, the rectangular strain sensitive resistors may be thick film or thin film resistors.

In some embodiments, the distance of the inner circular arc and the outer circular arc of the at least one arc-shaped resistor is between 1% and 80% of the membrane radius, preferably between 2% and 40% of the membrane radius.

In some embodiments, the Wheatstone bridge circuit comprises at least two inner rectangular strain sensitive resistors with a rectangular surface area arranged at an inner region of the membrane and at least two outer arc-shaped strain sensitive resistors arranged at an outer region of the membrane.

The at least two outer arc-shaped strain sensitive resistors may therefore be arranged at the outer region of the membrane where the strain of the membrane due to pressure variations in the measurement medium may be negative. The at least two inner rectangular strain sensitive resistors on the other hand may be arranged at the inner region of the membrane where the strain of the membrane due to pressure variations in the measurement medium may be positive. Providing rectangular strain sensitive resistors in the inner region of the membrane may be advantageous for a small membrane or pressure measuring cell, respectively, where the available space, especially in the central region of the membrane, is small.

In some embodiments, the Wheatstone bridge circuit comprises one or more auxiliary arc-shaped resistors at one or more positions of the membrane with minimal strain.

The one or more auxiliary arc-shaped resistors may be used as balancing resistors for balancing the Wheatstone bridge circuit.

By arranging the one or more auxiliary arc-shaped resistors at positions of the membrane with minimal strain, influence of pressure variations of the measurement medium on the resistance of the one or more auxiliary arc-shaped resistors can be reduced or minimized, which is particularly advantageous for the use as balancing resistors. For this purpose, the one or more auxiliary arc-shaped resistors may be arranged at circular arc regions with minimal strain of the membrane when the measurement medium exhibits pressure variations. Thereby, the arc shape of the one or more auxiliary arc-shaped resistors allows to optimize the independence of the resistance of the one or more auxiliary resistors from pressure variations of the measurement medium, compared to e.g. rectangular auxiliary resistors. The auxiliary resistors may be adjusted by laser trimming after depositing onto the membrane.

In some embodiments, at least one of the one or more auxiliary arc-shaped resistors is serially connected to one or more of the plurality of strain sensitive resistors.

In some embodiments, at least one of the one or more auxiliary arc-shaped resistors is connected in parallel to one or more of the plurality of strain sensitive resistors.

The one or more auxiliary arc-shaped resistors may also be connected in series or in parallel to other one or more of the one or more auxiliary arc-shaped resistors.

In some embodiments, the one or more auxiliary arc-shaped resistors are deposited onto the membrane by screen printing, ink jet printing, aerosol jet printing, stencil printing, vapor deposition or sputtering.

In some embodiments, the plurality of strain sensitive resistors is deposited onto the membrane by screen printing, ink jet printing, aerosol jet printing, stencil printing, vapor deposition or sputtering.

The different deposition methods may be used depending on different requirements for the resistors. For example, depositing the one or more auxiliary arc-shaped resistors and/or strain sensitive resistors by aerosol jet printing may be advantageous to obtain more precise shapes and smaller dimensions of the auxiliary arc-shaped resistors and/or strain sensitive resistors compared to e.g. screen printing.

In some embodiments, one or more of the at least one arc-shaped resistor may exhibit a structure with an overall rectangular surface area, wherein the inner circular arc and the outer circular arc radially delimiting the arc-shaped surface area of the arc-shaped resistor are provided by arc-shaped first and second electrical contacts. Although the arc-shaped resistor may comprise an overall rectangular surface area or other surface area deviating from an arc-shaped surface, the effective resistor area may therefore be arc-shaped due to the arc-shaped first and second electrical contacts radially delimiting the arc-shaped area of the arc-shaped resistor. For such embodiments, the arc-shaped surface area of the arc-shaped resistor shall therefore be understood as an effective resistor area delimited by the first and second electrical contacts.

According to a further aspect, the present invention is also directed to a pressure sensor comprising a pressure measuring cell according to the present disclosure.

According to a further aspect, the present invention is also directed to a method of manufacturing a pressure measuring cell according to the present disclosure, wherein the plurality of strain sensitive resistors and/or auxiliary resistors is deposited onto the membrane by aerosol jet printing.

### BRIEF DESCRIPTION OF THE DRAWINGS

The terms Fig., Figs., Figure, and Figures are used interchangeably in the specification to refer to the corresponding figures in the drawings.

The present invention will be explained in more detail, by way of exemplary embodiments, with reference to the schematic drawings, in which:

FIG. 1a shows an illustration of an embodiment of a pressure measuring cell in a vertical cut view;

FIG. 1b shows an illustration of an embodiment of a pressure measuring cell in a vertical cut view;

FIG. 1c shows an illustration of an embodiment of a pressure measuring cell in a vertical cut view;

FIG. 2 shows an illustration of an embodiment of a pressure measuring cell in a top view;

FIG. 3 shows an illustration of an embodiment of a pressure measuring cell in a top view;

FIG. 4 shows an illustration of an embodiment of a pressure measuring cell in a top view;

FIG. 5 shows a diagram with typical strain distributions across the membrane of a pressure measuring cell.

### DETAILED DESCRIPTION

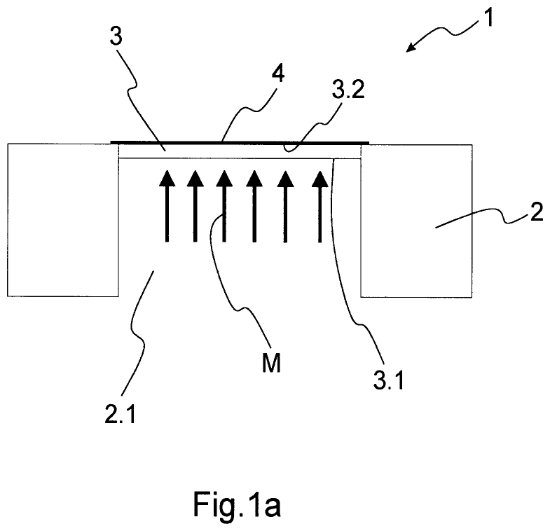

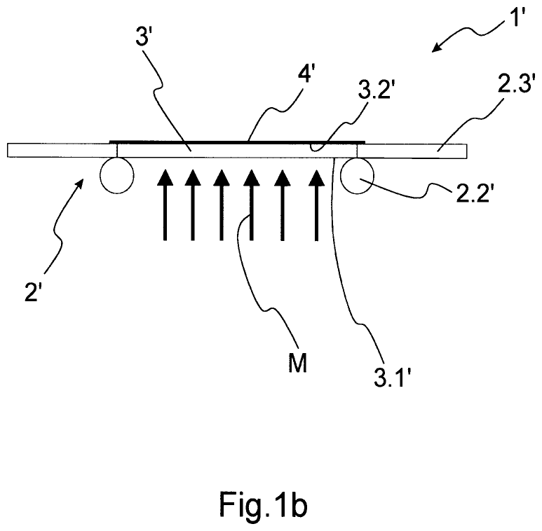

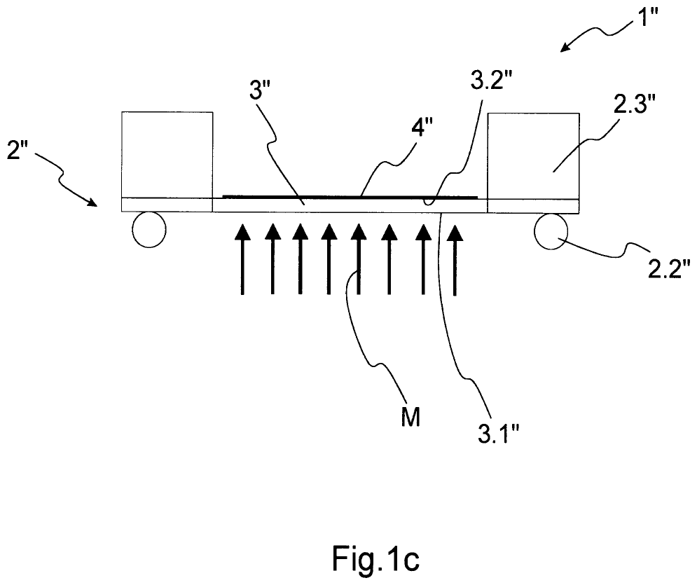

FIG. 1a shows an embodiment of a pressure measuring cell 1 in a vertical cut view. The pressure measuring cell 1 comprises a support body 2 of a cylindrical shape and a circular-shaped flexible membrane 3 with a first surface 3.1 and a second surface 3.2. The support body 2 supports the membrane 3 and comprises a cavity 2.1 which is axially delimited at a first side by the first surface 3.1 of the membrane 3 and open at a second side. The cavity 2.1 accommodates a measurement medium M. The support body 2 supports the membrane 3 at its edge. On the second surface 3.2 of the membrane 3, there is arranged a strain sensitive electrical circuit 4 configured to sense pressure variations of the measurement medium M, as symbolized by the arrows pointing towards the membrane 3.

FIG. 1b shows an embodiment of a pressure measuring cell 1′ comprising a support body 2′ and a membrane 3′ supported by the support body 2′. The support body 2′ comprises a torus 2.2′ in the form of a sealing ring encircling the membrane 3′ at its first surface 3.1′ and supporting the membrane 3′ at the first surface 3.1′. The support body 2′ further comprises a disc 2.3′ encircling the membrane 3′ at its edge and supporting the membrane 3′ thereat. A strain sensitive electrical circuit 4′ is arranged on the second surface 3.2′ of the membrane 3′ and configured to sense pressure variations of the measurement medium M facing the first surface 3.1′ of the membrane 3′. The pressure variations of the measurement medium M are symbolized by the arrows pointing towards the membrane 3′.

FIG. 1c shows an embodiment of a pressure measuring cell 1″ comprising a support body 2″ and a membrane 3″ supported by the support body 2″. The support body 2″ comprises a glass support disc 2.3″ of a cylindrical shape supporting the membrane 3″ at the second surface 3.2″ and a torus 2.2″ in the form of a sealing ring arranged at the side of the first surface 3.1″ of the membrane 3″. A strain sensitive electrical circuit 4″ is arranged on the second surface 3.2″ of the membrane 3″ and configured to sense pressure variations of the measurement medium M facing the first surface 3.1″ of the membrane 3″. The pressure variations of the measurement medium M are symbolized by the arrows pointing towards the membrane 3″.

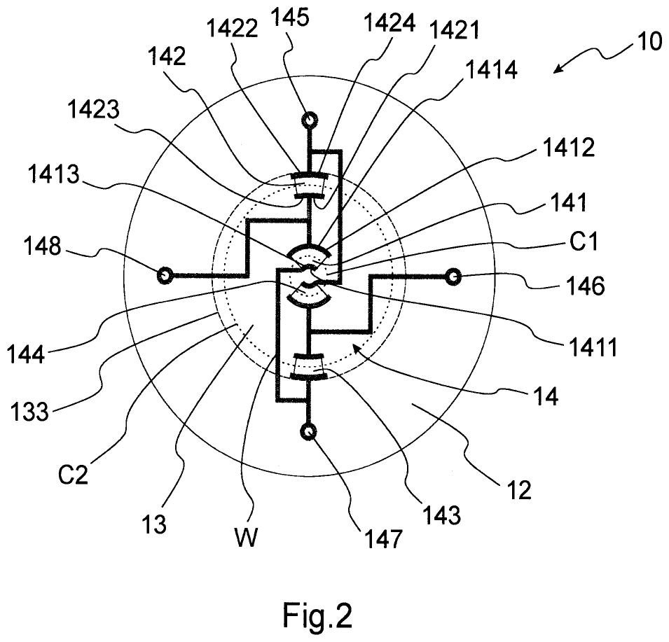

FIG. 2 shows an embodiment of a pressure measuring cell 10 in a top view showing a strain sensitive electrical circuit 14 arranged on a second surface of a circular-shaped membrane 13. The circular-shaped membrane 13 exhibits a circular edge 133 to which the support body 12 adjoins. The strain sensitive electrical circuit 14 comprises strain sensitive resistors 141, 142, 143, 144 connected by electrical W conductors in a Wheatstone bridge circuit. The strain sensitive resistors 141, 142, 143, 144 are arc-shaped resistors comprising an arc-shaped surface area that is radially delimited by an inner circular arc and an outer circular arc. For example, the surface area of the arc-shaped resistor 141 is radially delimited by the inner circular arc 1411 and the outer circular arc 1412 and the surface area of the arc-shaped resistor 142 is radially delimited by the inner circular arc 1421 and the outer circular arc 1422. The surface areas of the arc-shaped resistors 143 and 144 are analogously radially delimited.

The arc-shaped resistors 141, 142, 143, 144 are arranged on the circular-shaped membrane 13 in a manner that the inner circular arc and the outer circular arc are parallel to the circular edge 133 of the circular-shaped membrane 13. The arc-shaped resistors 141, 142, 143, 144 each comprise a first electrical contact arranged at the inner circular arc and a second electrical contact arranged at the outer circular arc. In particular, the first electrical contact of each of the arc-shaped resistors 141, 142, 143, 144 extends along the entire respective inner circular arc and the second electrical contact extends along the entire respective outer circular arc. As an example, the first electrical contact 1413 and the second electrical contact 1414 of the arc-shaped resistor 141 and the first electrical contact 1423 and the second electrical contact 1424 of the arc-shaped resistor 142 are denoted by reference numerals in FIG. 2.

The arc-shaped resistors 141, 142, 143, 144 are sheet resistors with a filled surface area. Due to the configuration of the first and second electrical contacts, current flows predominantly in radial direction. In azimuthal direction, the arc-shaped resistors 141, 142, 143, 144 are delimited by line segments which coincide with lines extending from the center of the circular shaped membrane 13 (or radial lines, respectively). The angle of the circle C1 covered by the inner arc-shaped resistors 141, 144 is larger than the angle of the circle C2 covered by the outer arc-shaped resistors 142, 143. In some embodiments, the proportion of the angles may be opposite, such that the angle of the circle C1 covered by the inner arc-shaped resistors may be smaller than the angle of the circle C2 covered by the outer arc-shaped resistors.

The arc-shaped resistors 141 and 144 are arranged on a first circle C1 parallel to the circular edge 133 of the membrane. The arc-shaped resistors 142 and 143 are arranged on a second circle C2 parallel to the circular edge 133 of the membrane, wherein the radius of the outer second circle C2 is larger than the radius of the first circle C1. The arc-shaped resistors 141 and 144 are arranged at positions where the combined surface strain of the membrane 13 due to pressure variations of the measurement medium is positive, whereas the arc-shaped resistors 142 and 143 are arranged at positions where the combined surface strain of the membrane 13 due to pressure variations of the measurement medium is negative.

The strain sensitive electrical circuit 14 comprises electrical contacts 145, 146, 147, 148 which are arranged on the support body 12. The electrical contacts 145, 147 are used as supply terminals and the electrical contacts 146, 148 are used as sensing terminals. Due to the symmetry of the circuit, the role of the electrical contacts 145, 147 and 146, 148 as sense and supply terminals may also be reversed.

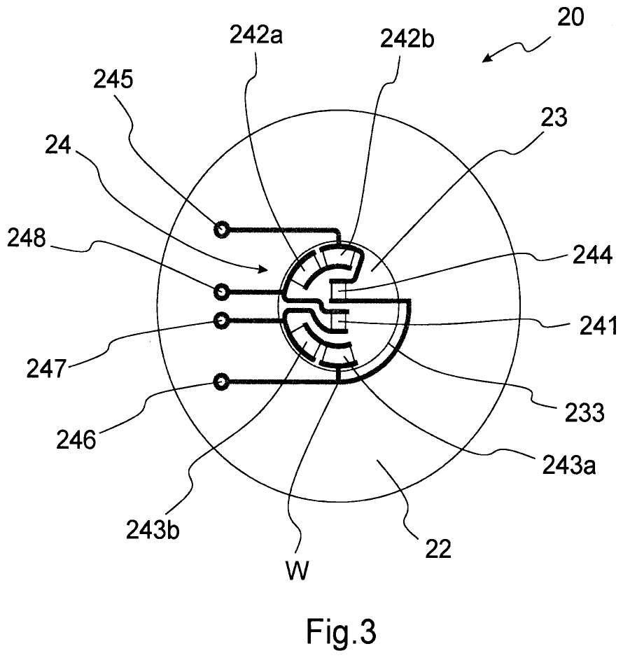

FIG. 3 shows an embodiment of an embodiment of a pressure measuring cell 20 with a support body 22 and a strain sensitive electrical circuit 24 arranged on a second surface of a circular-shaped membrane 23. Compared to the embodiment as shown in FIG. 2, the pressure measuring cell 20 comprises a smaller membrane 23. Accordingly, the available space for the strain sensitive resistors is reduced. The support body 22 has a larger surface area than the support body 12 of the embodiment of FIG. 2. However, the support body 22 may also have a comparable surface area or a smaller surface area than the support body 12 of the embodiment of FIG. 2.

The strain sensitive electrical circuit 24 comprises strain sensitive resistors 241, 242a, 242b, 243a, 243b, 244 connected by electrical conductors W in a Wheatstone bridge circuit. The strain sensitive resistors 241, 244 are rectangular strain sensitive resistors and arranged at an inner region of the membrane. The arc-shaped resistors 242a, 242b are connected in series and correspond to one arc-shaped resistor, similar to the arc-shaped resistor 142 of the embodiment shown in FIG. 2. Accordingly, the arc-shaped resistors 243a, 243b are connected in series and correspond to one arc-shaped resistor, similar to the arc-shaped resistor 143 of the embodiment of FIG. 2. The four arc-shaped resistors 242a, 242b, 243a, 243b are arranged on a circle parallel to and near the circular edge of the membrane 23.

The rectangular strain sensitive resistors 241, 244 and the arc-shaped resistors 242a-b, 243a-b are for example manufactured by aerosol jet printing. The rectangular strain sensitive resistors 241, 244 are arranged at positions where the combined surface strain of the membrane 23 due to pressure variations of the measurement medium is positive, whereas the arc-shaped resistors 242a-b and 243a-b are arranged at positions where the combined surface strain of the membrane 23 due to pressure variations of the measurement medium is negative.

The electrical contacts 245, 246, 247, 248 are arranged on the left side of the top surface of the support body 22. The electrical contacts 245, 247 are used as supply terminals and the electrical contacts 246, 248 are used as sensing terminals. Due to the symmetry of the circuit, the role of the electrical contacts 245, 247 and 246, 248 as sense and supply terminals may also be reversed.

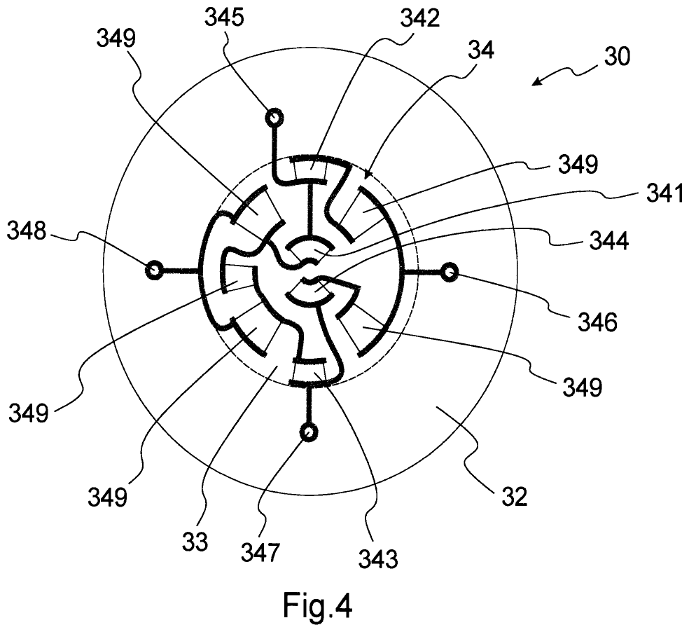

FIG. 4 shows an embodiment of a pressure measuring cell 30 comprising a support body 32 and a membrane 33 on which a strain sensitive electrical circuit 34 is arranged. The strain sensitive electrical circuit 34 comprises arc-shaped strain sensitive resistors 341, 342, 343, 344 connected in Wheatstone bridge circuit. The arrangement of the arc-shaped strain sensitive resistors 341, 342, 343, 344 is similar to the arrangement of the resistors 141, 142, 143, 144 of the shown in FIG. 2. However, the strain sensitive electrical circuit 34 or the Wheatstone bridge circuit, respectively, comprises a plurality of auxiliary arc-shaped resistors 349 arranged at one or more positions of the membrane 33 with minimal strain. Specifically, the auxiliary arc-shaped resistors 349 are arranged on a circle with minimal strain. The auxiliary arc-shaped resistors 349 are connected in series or in parallel to the arc-shaped strain sensitive resistors 341, 342, 343, 344.

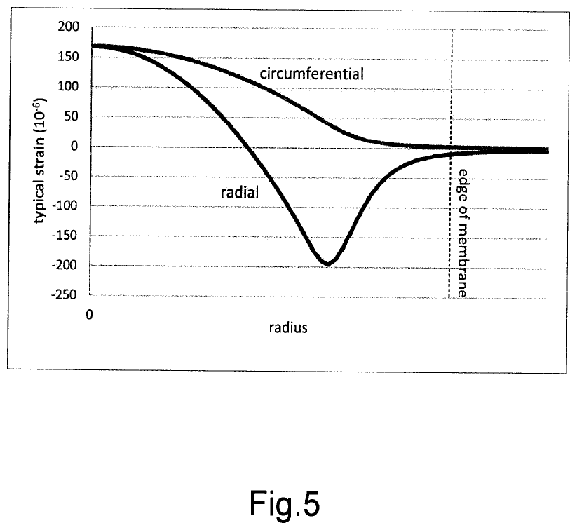

FIG. 5 shows a diagram with typical strain distributions across the circular-shaped membrane of a pressure measuring cell for pressure variations occurring in the measurement medium. The diagram shows a first graph of the radial strain distribution and a second graph of the circumferential or azimuthal strain distribution, respectively. As can be seen in the diagram, the strain is large in the center of the membrane and decreases towards the edge of the membrane. The radial strain decreases faster than the circumferential strain and reaches zero at a certain position between the center and the edge of the membrane. Beyond the zero-crossing, the radial strain becomes negative. After reaching a local minimum, the negative strain increases again to near zero towards the edge of the membrane.

The auxiliary resistors of the pressure measuring cell according to the present disclosure, such as for example the auxiliary resistors 349 of FIG. 4, are therefore advantageously positioned along or near the circle on the membrane where the combined surface strain exhibits a zero-crossing, in order to reduce or minimize the influence of pressure variations of the measurement medium on the resistance of the one or more auxiliary resistors and to use the auxiliary resistors as balancing resistors. It can also be recognized from the diagram that for the arc-shaped resistors 142 and 143 of the embodiment shown in FIG. 2 (or the arc-shaped resistors 242a-b, 243a-b of FIG. 3 or the arc-shaped resistors 342, 343 of FIG. 4), the radial strain is negative, having a decreasing effect on its resistances. For the inner resistors 141 and 144 of the embodiment shown in FIG. 2 (or the inner resistors 241, 244 of FIG. 3 or the resistors 341, 344 of FIG. 4), the radial strain is positive, thus having an increasing effect on its resistances. For the present disclosure, the term “strain” shall typically be understood as the combined strain of radial and circumferential strain.

1. A pressure measuring cell comprising a support body and a circular-shaped membrane comprising a first surface and a second surface, the support body supporting the circular-shaped membrane, wherein the pressure measuring cell further comprises a plurality of strain sensitive resistors arranged on the second surface of the circular-shaped membrane and connected in a Wheatstone bridge circuit, wherein at least one strain sensitive resistor is an arc-shaped resistor comprising an arc-shaped surface area that is radially delimited by an inner circular arc and an outer circular arc.

2. The pressure measuring cell according to claim 1, wherein the at least one arc-shaped resistor is arranged on the circular-shaped membrane such that the inner circular arc and the outer circular arc are parallel to a circular edge of the circular-shaped membrane.

3. The pressure measuring cell according to claim 1, wherein the at least one arc-shaped resistor comprises a first electrical contact which is arranged at the inner circular arc and a second electrical contact which is arranged at the outer circular arc.

4. The pressure measuring cell according to claim 3, wherein the first electrical contact extends along the inner circular arc and/or the second electrical contact extends along the outer circular arc.

5. The pressure measuring cell according to claim 1, wherein the at least one arc-shaped resistor is delimited in azimuthal direction by line segments which coincide with lines extending from the center of the circular-shaped membrane.

6. The pressure measuring cell according to claim 1, wherein the at least one arc-shaped resistor is a sheet resistor with a filled surface area.

7. The pressure measuring cell according to claim 1, wherein the plurality of strain sensitive resistors comprises two, three, four, five, six, seven or eight arc-shaped resistors.

8. The pressure measuring cell according to claim 7, wherein two first arc-shaped resistors are arranged on a first circle parallel to a circular edge of the circular-shaped membrane.

9. The pressure measuring cell according to claim 8, wherein two second arc-shaped resistors are arranged on a second circle parallel to the first circle, wherein a radius of the second circle is larger than a radius of the first circle.

10. The pressure measuring cell according to claim 7, wherein four arc-shaped resistors are arranged on a circle parallel to a circular edge of the circular-shaped membrane.

11. The pressure measuring cell according to claim 1, wherein the at least one arc-shaped resistor covers a circular arc with an angle between 10° and 180°.

12. The pressure measuring cell according to claim 1, wherein the at least one arc-shaped resistor is a thick film resistor.

13. The pressure measuring cell according to claim 1, wherein the at least one arc-shaped resistor is a thin film resistor.

14. The pressure measuring cell according to claim 1, wherein the distance of the inner circular arc and the outer circular arc of the at least one arc-shaped resistor is between 1% and 80% of a radius membrane.

15. The pressure measuring cell according to claim 1, wherein the Wheatstone bridge circuit comprises at least two inner rectangular strain sensitive resistors with a rectangular surface area arranged at an inner region of the circular-shaped membrane and at least two outer arc-shaped strain sensitive resistors arranged at an outer region of the circular-shaped membrane.

16. The pressure measuring cell according to claim 1, wherein the Wheatstone bridge circuit comprises one or more auxiliary arc-shaped resistors at one or more positions of the circular-shaped membrane (33) with minimal strain.

17. The pressure measuring cell according to claim 16, wherein at least one of the one or more auxiliary arc-shaped resistors is serially connected to one or more of the plurality of strain sensitive resistors.

18. The pressure measuring cell according to claim 16, wherein at least one of the one or more auxiliary arc-shaped resistors is connected in parallel to one or more of the plurality of strain sensitive resistors.

19. The pressure measuring cell according to claim 16, wherein the one or more auxiliary arc-shaped resistors are deposited onto the circular-shaped membrane by screen printing, ink jet printing, aerosol jet printing, stencil printing, vapor deposition or sputtering.

20. The pressure measuring cell according to claim 1, wherein the plurality of strain sensitive resistors is deposited onto the circular-shaped membrane by screen printing, ink jet printing, aerosol jet printing, stencil printing, vapor deposition or sputtering.

21. A pressure sensor comprising the pressure measuring cell according to claim 1.

22. A method of manufacturing the pressure measuring cell according to claim 19, wherein the plurality of strain sensitive resistors and/or auxiliary resistors is deposited onto the membrane by aerosol jet printing.
